(19) United States
(12) Patent Application Publication
(10) Pub. No.: US 2012/0182177 A1
(43) Pub. Date: Jul. 19, 2012

(54) MIXER MONITORING

(76) Inventors: Armin Himmelstoss, Weissach Im Tal (DE); Maija Chabaud, Tamm (DE)

(21) Appl. No.: 13/381,257

(22) PCT Filed: May 3, 2010
(86) PCT No.: PCT/EP2010/055951

§ 371 Date: Apr. 9, 2012

(30) Foreign Application Priority Data
Jul. 1, 2009 (DE) 10 2009 027 368.9

(51) Int. Cl. G01S 7/40

(52) U.S. Cl. 342/173

(57) ABSTRACT

In a method for checking the functionality of a mixer, the mixer is supplied with a high-frequency signal and a high-frequency comparison signal in order to generate a baseband signal. The amplitude of the high-frequency signal is modified as a function of time. A direct-current voltage component of the baseband signal which is output by the mixer is analyzed to determine the functionality of the mixer.

### BACKGROUND OF THE INVENTION

1. Field of the Invention

The present invention relates to a method for checking the functionality of a mixer, and an electronic circuit system.

2. Description of Related Art

Microwave mixers are used in radar systems to mix a high-frequency transmission signal with a received reflection signal, thus obtaining a baseband signal having a lower frequency but which still has the same information content as the reflection signal. It is necessary to monitor the mixer function in safety-relevant systems. However, in the related art either no monitoring, or only simple, insensitive monitoring, of the mixers is used.

### BRIEF SUMMARY OF THE INVENTION

An object of the present invention is to provide a method for checking the functionality of a mixer. Moreover, another object of the present invention is to provide an electronic circuit system for checking the functionality of a mixer.

In a method according to the present invention for checking the functionality of a mixer, the mixer is supplied with a high-frequency signal in order to generate a baseband signal. The amplitude of the high-frequency signal is modified as a function of time. In addition, a direct-current voltage component of the baseband signal which is output by the mixer is analyzed to determine the functionality of the mixer. The method is advantageously suited for checking the functionality of passive and active mixers. The method is cost-neutral in implementation and is EMC-compliant, and allows simple control and monitoring.

In one refinement, the mixer is supplied with a high-frequency comparison signal in addition to the high-frequency signal.

According to one specific embodiment, the mixer is part of a radar system. The high-frequency signal is used as the transmission signal of the radar system, and a reflection signal received by the radar system is used as the comparison signal. This advantageously allows the functionality of the mixer of the radar system to be checked without having to modify the wiring of the mixer.

A variation of the direct-current voltage component of the baseband signal over time is preferably analyzed. To protect against other influences, the modulation frequency and its amplitude in the spectrum may be verified.

According to one specific embodiment of the method, the amplitude of the high-frequency signal is modulated using an amplitude modulation frequency. Such an amplitude modulation may advantageously and easily be carried out using an amplifier having an adjustable gain factor, or using another switchable source.

In one refinement of the method, the magnitude of a signal level of the baseband signal at the amplitude modulation frequency of the high-frequency signal is compared to a fixed limiting value, and the mixer is assessed as functional if the limiting value is exceeded. For such an analysis in the frequency domain, any interfering influences, for example as the result of radar targets, are advantageously eliminated.

In an additional refinement of the method, during a first time interval the amplitude of the high-frequency signal is modulated using a first amplitude modulation frequency, and during a second time interval is modulated using a second amplitude modulation frequency. A random superimposition of the amplitude modulation frequency by a signal which is generated by a reflection on an object present in the surroundings of the radar system may advantageously be recognized in this way.

According to another specific embodiment of the method, during a first time interval the high-frequency signal has a first amplitude which is constant over time, and during a second time interval has a second amplitude which is constant over time. The mixer is assessed as functional if the direct-current voltage component of the baseband signal in the second time interval has a different value than in the first time interval. In this specific embodiment, the method may advantageously be carried out even more easily.

An electronic circuit system according to the present invention includes a mixer for mixing a high-frequency signal and a high-frequency comparison signal, and for outputting a baseband signal. A device is provided for modifying the amplitude of the high-frequency signal as a function of time. An analysis circuit is also provided for assessing the functionality of the mixer based on a comparison of a change in a direct-current voltage component of the baseband signal over time with the change in the amplitude of the high-frequency signal over time. The circuit system is advantageously suited for checking the functionality of passive and active mixers. The circuit system is EMC-compliant and allows simple control and monitoring.

The mixer is preferably part of a radar system.

The mixer is advantageously a diode mixer or a Gilbert cell.

### BRIEF DESCRIPTION OF THE DRAWINGS

FIG. 1 shows a schematic block diagram of a radar system.

FIG. 2 shows a schematic illustration of a variation of an amplitude-modulated high-frequency signal and of a baseband signal over time.

### DETAILED DESCRIPTION OF THE INVENTION

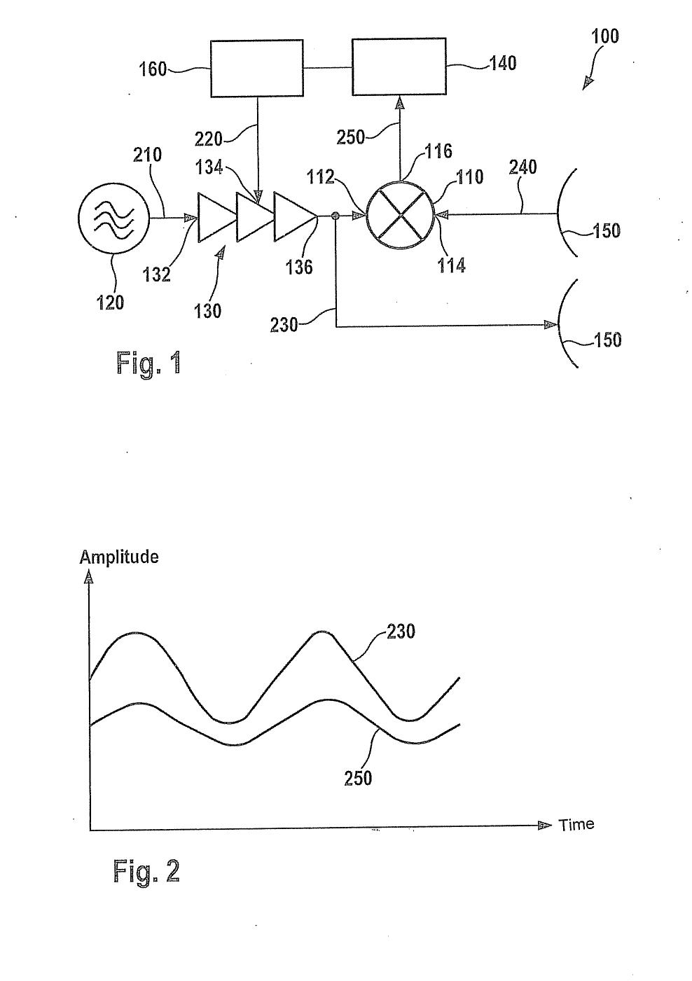

FIG. 1 shows a schematic illustration of a radar system 100. Radar system 100 may be a frequency-modulated continuous-wave radar, for example. Radar system 100 may be used, for example, for adaptive cruise control in a motor vehicle.

Radar system 100 has a voltage-controlled oscillator 120. The voltage-controlled oscillator is used for generating a high-frequency signal 210. High-frequency signal 210 may have a frequency in the range of 77 GHz, for example. The voltage-controlled oscillator preferably allows setting of the frequency of high-frequency signal 210. Instead of voltage-controlled oscillator 120, another component may be used for generating high-frequency signal 210.

Radar system 100 also includes an amplifier 130 having an adjustable gain factor. Amplifier 130 has an amplifier input 132, a modulation input 134, and an amplifier output 136. Amplifier input 132 is connected to voltage-controlled oscillator 120, and receives high-frequency signal 210. Modulation input 134 receives a modulation signal 220. The gain factor of amplifier 130 may be adjusted via modulation signal 220 which is present at modulation input 134. Amplifier 130 amplifies high-frequency signal 210 which is present at amplifier input 132, and outputs it as an amplified high-frequency signal 230 via amplifier output 136. If the magnitude of modulation signal 220 present at modulation input 134 changes as a function of time, high-frequency signal 210 present at amplifier input 132 is additionally amplitude-modulated by amplifier 130 and output as an amplitude-modulated amplified high-frequency signal 230. If a signal which is constant over time is present at modulation input 134, amplifier 130 does not carry out amplitude modulation.

Radar system 100 also includes an antenna 150 for transmitting high-frequency signal 230. Antenna 150 may also be used for receiving a comparison signal 240 which is reflected from objects possibly present in the surroundings of radar system 100. In this case, a circulator (not illustrated in FIG. 1) separates transmitted high-frequency signal 230 and received comparison signal 240. Alternatively, separate antennas 150 may be used for the transmission and reception, as illustrated in FIG. 1.

Radar system 100 also includes a mixer 110 having a LO input 112, an RF input 114, and a baseband output 116. Mixer 110 is a microwave mixer for frequency conversion. Mixer 110 may be a passive diode mixer or an active mixer, for example a Gilbert cell. LO input 112 is connected to amplifier output 136, and receives amplified high-frequency signal 230. Comparison signal 240 is present at RF input 114. Signal 230 present at LO input 112 and the signal present at RF input 114 have approximately the same frequency. Mixer 110 may be a homodyne mixer or a monodyne mixer.

Mixer 110 multiplies amplified high-frequency signal 230 by comparison signal 240. In other words, amplified high-frequency signal 230 is modulated to comparison signal 240. Mixer 110 thus generates a baseband signal 250 which is output via baseband output 116. Baseband signal 250 contains signal components whose frequency corresponds to the difference in the frequencies of amplified high-frequency signal 230 and of comparison signal 240.

During normal operation of radar system 100, the frequency of high-frequency signal 210, and similarly also of amplified high-frequency signal 230, is changed in a ramp-shaped manner as a function of time. A modulation signal 220 which is constant over time is present at modulation input 134 of amplifier 130, so that amplifier 130 does not modulate the amplitude of the amplified high-frequency signal. Amplified high-frequency signal 230 is emitted via antenna 150. Objects present in the surroundings of radar system 100 reflect amplified high-frequency signal 230 back to antenna 150, where it is received as comparison signal 240. Due to the propagation time of amplified high-frequency signal 230 to the reflecting object and back to antenna 150, the frequency of amplified high-frequency signal 230 has already changed by the time comparison signal 240 is received, so that there is a frequency difference between amplified high-frequency signal 230 and received comparison signal 240 which is a function of the distance of the reflecting object from radar system 100. Mixer 110 generates baseband signal 250, whose frequency corresponds to this frequency difference. Based on the frequency of baseband signal 250, an analysis circuit then deduces the distance of the reflecting object from radar system 100. In order to also compensate for Doppler shifts caused by relative speeds which exist between radar system 100 and the reflecting object, multiple consecutive measuring cycles may be carried out in which the change in the frequency of high-frequency signal 210 and of amplified high-frequency signal 230 over time occurs with different slopes.

If the frequency difference between amplified high-frequency signal 230 and comparison signal 240 is small, the frequency of baseband signal 250 generated by mixer 110 is also small.

If amplified high-frequency signal 230 and comparison signal 240 have the same frequency, mixer 110 outputs a direct-current voltage at baseband output 116, or baseband signal 250 has a direct-current voltage component. In the present invention it has been found that for a functional mixer 110, the magnitude of the direct-current voltage component in baseband signal 250 is a function of the amplitude of amplified high-frequency signal 230, whereas this is not the case for a defective mixer 110. In one simplified specific embodiment, it is not necessary to supply mixer 110 with a comparison signal 240. Even without a comparison signal 240 present, baseband signal 250 which is output by mixer 110 has a direct-current voltage component whose magnitude for a functional mixer 110 is a function of the amplitude of amplified high-frequency signal 230.

In both cases, the functionality of mixer 110 may be deduced based on the presence of a dependency of the magnitude of the direct-current voltage component of baseband signal 250 on the amplitude of amplified high-frequency signal 230. For this purpose, radar system 100 has an amplitude modulation device 160 which is connected to modulation input 134 of amplifier 130. Amplitude modulation device 160 outputs modulation signal 220 in order to modify the gain factor of amplifier 130 as a function of time, and thus to modulate the amplitude of amplified high-frequency signal 230 which is output by amplifier 130. Radar system 100 also has an analysis circuit 140 which receives and analyses baseband signal 250 which is output by mixer 110. Analysis circuit 140 is also connected to amplitude modulation device 160 in order to control the amplitude modulation. Analysis circuit 140 checks whether a direct-current voltage component of baseband signal 250 changes corresponding to the amplitude modulation of amplified high-frequency signal 230 which is carried out by amplitude modulation device 160. If this is the case, analysis circuit 140 deduces that mixer 110 is functional.

Such checking of the functionality of mixer 110 preferably takes place during a period of time in which the frequency of high-frequency signal 210 and of amplified high-frequency signal 230 undergoes little or no change over time. A measuring cycle for checking the functionality of mixer 110 may be 1 millisecond, for example. The amplitude modulation of amplified high-frequency signal 230 is then switched off, and radar system 100 is returned to normal operation.

The amplitude of amplified high-frequency signal 230 may be periodically modulated using an amplitude modulation frequency. FIG. 2 shows an example of a variation of such an amplitude-modulated amplified high-frequency signal 230 over time. FIG. 2 also schematically illustrates the expected variation in baseband signal 250 over time when mixer 110 is functional. The magnitude of the direct-current voltage component of baseband signal 250 is likewise modulated using the amplitude modulation frequency. Any phase shift between amplified high-frequency signal 230 and baseband signal 250 has not been taken into account in FIG. 2, and plays no role in the further analysis.

Analysis circuit 140 may analyze amplified-modulated baseband signal 250 in the frequency domain, for example. For this purpose, analysis circuit 140 carries out a Fourier transformation of received baseband signal 250, and checks whether the spectrum of baseband signal 250 thus obtained has a maximum at the amplitude modulation frequency. Any interfering influences at other frequencies are advantageously eliminated in this way.

To exclude random superimposition of the amplitude modulation frequency with signal components in baseband signal 250 caused by a reflection on an object in the surroundings of radar system 100, two or more consecutive cycles may be carried out at different amplitude modulation frequencies.

In one alternative specific embodiment of the present invention, the analysis of baseband signal 250 may also be carried out by analysis circuit 140 in the time domain. For example, it is not possible for the amplitude of amplified high-frequency signal 230 to be periodically modulated; rather, the amplitude may only be switched between a first and a second value. For the switch between the first value of the amplitude of amplified high-frequency signal 230 and the second value of the amplitude of amplified high-frequency signal 230, when mixer 110 is functional, the magnitude of the direct-current voltage component of baseband signal 250 should also change. If this is not the case, it may be concluded that mixer 110 is defective.

1-12. (canceled)

13. A method for checking the functionality of a mixer, comprising:
supplying the mixer with a high-frequency signal in order to generate a baseband signal;
modifying the amplitude of the high-frequency signal as a function of time; and
analyzing a direct-current voltage component of the baseband signal output by the mixer to determine the functionality of the mixer.

14. The method as recited in claim 13, wherein the mixer is further supplied with a high-frequency comparison signal in addition to the high-frequency signal.

15. The method as recited in claim 14, wherein the mixer is part of a radar system, and wherein the high-frequency signal is used as the transmission signal of the radar system, and a reflection signal received by the radar system is used as the comparison signal.

16. The method as recited in claim 14, wherein a variation of the direct-current voltage component of the baseband signal over time is analyzed.

17. The method as recited in claim 16, wherein the amplitude of the high-frequency signal is modulated using an amplitude modulation frequency.

18. The method as recited in claim 17, wherein the magnitude of a signal level of the baseband signal at the amplitude modulation frequency of the high-frequency signal is compared to a fixed limiting value, and the mixer is assessed as functional if the limiting value is exceeded.

19. The method as recited in claim 17, wherein during a first time interval the amplitude of the high-frequency signal is modulated using a first amplitude modulation frequency, and wherein during a second time interval the amplitude of the high-frequency signal is modulated using a second amplitude modulation frequency.

20. The method as recited in claim 17, wherein during a first time interval the high-frequency signal has a first amplitude which is constant over time, and during a second time interval the high-frequency signal has a second amplitude which is constant over time, wherein the mixer is assessed as functional if the direct-current voltage component of the baseband signal in the second time interval has a different value than in the first time interval.

21. An electronic circuit system, comprising:
a mixer configured to i) mix a high-frequency signal and a high-frequency comparison signal, and ii) output a baseband signal;
a device provided to modify the amplitude of the high-frequency signal as a function of time; and
an analysis circuit configured to assess the functionality of the mixer based on a comparison of a change in a direct-current voltage component of the baseband signal over time with the change in the amplitude of the high-frequency signal over time.

22. The electronic circuit system as recited in claim 21, wherein the mixer is part of a radar system.

23. The electronic circuit system as recited in claim 21, wherein the mixer is a diode mixer.

24. The electronic circuit system as recited in claim 21, wherein the mixer is a Gilbert cell.
